(19) United States
(12) Patent Application Publication
(10) Pub. No.: US 2023/0075579 A1
(43) Pub. Date: Mar. 9, 2023

(54) PSEUDOPLASTIC FLOW CONTROL DEVICE, METHOD AND SYSTEM

(71) Applicants: Joshua Raymond Snitkoff, Houston, TX (US); Navin Sakthivel, Spring, TX (US)

(72) Inventors: Joshua Raymond Snitkoff, Houston, TX (US); Navin Sakthivel, Spring, TX (US)

(73) Assignee: Baker Hughes Oilfield Operations LLC, Houston, TX (US)

(21) Appl. No.: 17/470,511

(22) Filed: Sep. 9, 2021

(51) Int. Cl. F16L 55/027; E21B 34/08

(52) U.S. Cl. CPC F16L 55/02754; E21B 34/08

(57) ABSTRACT

A flow control device including a flow passage defined by a structure, a material disposed at least partially within the flow passage, the material responsive to flow induced strain to alter flow of fluid through the passage. A method for controlling fluid flow through a passage including flowing a fluid in the passage, altering a pseudoplastic material disposed at least partially within the passage based upon a density of fluid flowing in the passage.

### BACKGROUND

In industries concerned with fluid flow control, controlling fluid flow automatically is desirable. While there are a number of ways one might create an automated flow control system, there are many situations in which known methods are inadequate. The art therefore is always receptive to novel means and methods that allow for control of systems not presently fully managed.

### SUMMARY

An embodiment of a flow control device including a flow passage defined by a structure, a material disposed at least partially within the flow passage, the material responsive to flow induced strain to alter flow of fluid through the passage.

An embodiment of a method for controlling fluid flow through a passage including flowing a fluid in the passage, altering a pseudoplastic material disposed at least partially within the passage based upon a density of fluid flowing in the passage.

### BRIEF DESCRIPTION OF THE DRAWINGS

The following descriptions should not be considered limiting in any way. With reference to the accompanying drawings, like elements are numbered alike:

FIG. 1 is a schematic illustration of a flow control device in a first condition;

FIG. 2 is the flow control device of FIG. 1 in a second condition; and

FIG. 3 is a view of a wellbore including control device disclosed herein.

### DETAILED DESCRIPTION

A detailed description of one or more embodiments of the disclosed apparatus and method are presented herein by way of exemplification and not limitation with reference to the Figures.

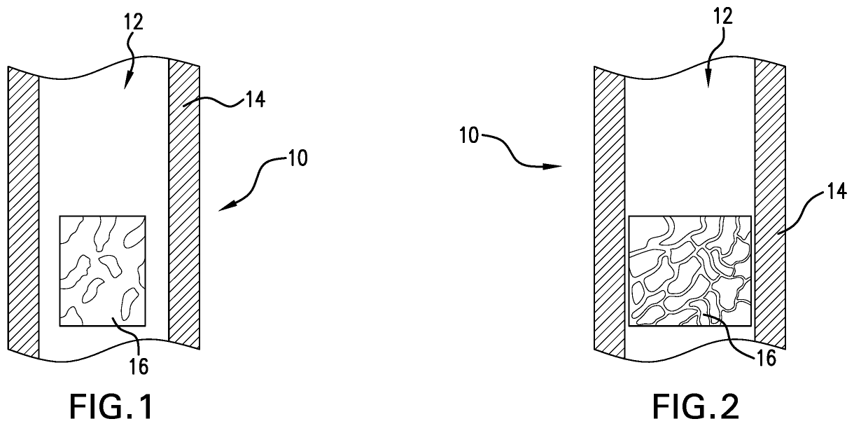

Referring to FIG. 1, a flow control device 10 is illustrated. The device 10 comprises a passage 12 defined within a structure 14 and a material 16 disposed at least partially in the passage 12. The material 16 is one that is responsive to flow induced strain to alter flow of fluid through the passage 12. Such material 16 may be a pseudoplastic material and may in some embodiments comprise a matrix material partially filled with a particulate material. More specifically, the matrix material may be a thermopolymer such as butadiene, polyetherimide, polyamide and combinations including at least one of the foregoing, in some embodiments. Also, in embodiments, the material may be filled with silica or aerogel. In one embodiment, the matrix is filled to about 30% to about 60% with the particulate (silica or aerogel as an example). Also, in an embodiment, the fill particles may include a dimension of about 10 to about 60 micrometers. Such materials may be made by bringing the matrix to a liquification temperature and admixing the particulate or may be created in an additive manner by printing the pseudoplastic material.

As noted above, the material 16 is a pseudoplastic material so that it will respond to shear strain within the material. In the device 10, this material is placed such that it is subject to flow induced strain from fluid flowing through the passage 12. Depending upon the density of fluid flowing through passage 12, there is more or less fluid induced stress applied to the material 16 and hence more or less strain within the material 16. The greater the density of flowing fluid, the greater the strain experienced by the material 16. In one example, an oil flowing in the passage 12 would exert a relatively low stress on the material 16 since it has a relatively low density. Water, conversely, due to its higher density, would exert a higher stress on the material 14.

When exposed to flows that increase the internal strain on the material 16, the material itself undergoes a change pursuant to its pseudoplastic nature. This results in porosity being reduced and overall dimensions of the material increasing. A reduced porosity and an increased occupancy of the passage 12 results, not surprisingly, in a reduced flow through passage 12. In one example, the device is used to exclude water in an oil well. Water is denser than oil and hence exerts a greater stress on the material 16, whereafter the material 16 reacts pseudoplastically to reduce the flow of that water. If oil is predominant in the flow however, density is less, so flow induced stress is less on material 16 is less. So too, then, is internal strain less and resultingly flow is allowed to continue through passage 12. The device 10 will of course work similarly for any fluids passed through the device 10 with differing fluid densities.

It is to be understood that the drawings and above disclosure directed to the drawings is by example only and the concept of employing a pseudoplastic to affect flow through a passage based primarily on the density of the fluid flowing therethrough is broader in nature than the drawings and disclosure. Pseudoplastic reacts to internal strain. Hence any system that creates internal strain that is related to a flow may be modified and controlled using a pseudoplastic valve that selectively reacts to the density of the fluid flowing therethrough or therearound.

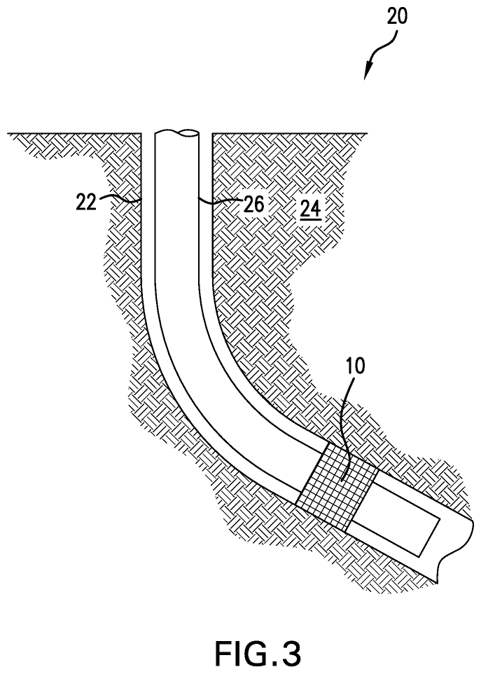

Referring to FIG. 3, a wellbore system 20 is illustrated. The system 20 comprises a borehole 22 in a subsurface formation 24. A string 26 is disposed in the borehole 22. A device 10 is disposed within or as a part of the string 26.

Set forth below are some embodiments of the foregoing disclosure:

Embodiment 1: A flow control device including a flow passage defined by a structure, a material disposed at least partially within the flow passage, the material responsive to flow induced strain to alter flow of fluid through the passage.

Embodiment 2: The device as in any prior embodiment wherein the material is a pseudoplastic.

Embodiment 3: The device as in any prior embodiment wherein the material exhibits a first porosity under conditions of relatively lesser flow induced strain and a second porosity under conditions of relatively greater flow induced strain.

Embodiment 4: The device as in any prior embodiment wherein the first porosity is greater than the second porosity.

Embodiment 5: The device as in any prior embodiment wherein the material exhibits a first set of overall dimensions under conditions of relatively lesser flow induced strain and a second set of overall dimensions under conditions of relatively greater flow induced strain.

Embodiment 6: The device as in any prior embodiment wherein the first set of overall dimensions is smaller than the second set of overall dimensions.

Embodiment 7: The device as in any prior embodiment wherein the flow induced strain is greater for fluids having a greater density than for fluids having a relatively lesser density.

Embodiment 8: The device as in any prior embodiment wherein the material responds to higher density fluid by restricting flow through the passage.

Embodiment 9: The device as in any prior embodiment wherein the material comprises a particulate disposed in a matrix.

Embodiment 10: The device as in any prior embodiment wherein the matrix is a thermoplastic.

Embodiment 11: The device as in any prior embodiment wherein the thermoplastic is butadiene, polyetherimide, polyamide and combinations including at least one of the foregoing.

Embodiment 12: The device as in any prior embodiment wherein the particulate is silica or aerogel.

Embodiment 13: The device as in any prior embodiment wherein the matrix is filled about 30 to about 60 percent with the particulate.

Embodiment 14: The device as in any prior embodiment wherein the particulate includes a dimension of about 10 micrometers to about 60 micrometers.

Embodiment 15: The device as in any prior embodiment wherein the device is an inflow control device for a resource recovery system.

Embodiment 16: The device as in any prior embodiment wherein the device is a part of another inflow control device for a resource recovery system.

Embodiment 17: A method for controlling fluid flow through a passage including flowing a fluid in the passage, altering a pseudoplastic material disposed at least partially within the passage based upon a density of fluid flowing in the passage.

Embodiment 18: The method as in any prior embodiment wherein the altering is expanding dimensions of solid portions of the material in response to denser fluid inducing strain in the material.

Embodiment 19: A wellbore system including a borehole in a subsurface formation, a string in the borehole, and a device as in any prior embodiment disposed within or as a part of the string.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% or 5%, or 2% of a given value.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A flow control device comprising:
a flow passage defined by a structure;
a material disposed at least partially within the flow passage, the material responsive to flow induced strain to alter flow of fluid through the passage.

2. The device as claimed in claim 1 wherein the material is a pseudoplastic.

3. The device as claimed in claim 1 wherein the material exhibits a first porosity under conditions of relatively lesser flow induced strain and a second porosity under conditions of relatively greater flow induced strain.

4. The device as claimed in claim 3 wherein the first porosity is greater than the second porosity.

5. The device as claimed in claim 1 wherein the material exhibits a first set of overall dimensions under conditions of relatively lesser flow induced strain and a second set of overall dimensions under conditions of relatively greater flow induced strain.

6. The device as claimed in claim 5 wherein the first set of overall dimensions is smaller than the second set of overall dimensions.

7. The device as claimed in claim 1 wherein the flow induced strain is greater for fluids having a greater density than for fluids having a relatively lesser density.

8. The device as claimed in claim 1 wherein the material responds to higher density fluid by restricting flow through the passage.

9. The device as claimed in claim 1 wherein the material comprises a particulate disposed in a matrix.

10. The device as claimed in claim 9 wherein the matrix is a thermoplastic.

11. The device as claimed in claim 10 wherein the thermoplastic is butadiene, polyetherimide, polyamide and combinations including at least one of the foregoing.

12. The device as claimed in claim 11 wherein the particulate is silica or aerogel.

13. The device as claimed in claim 10 wherein the matrix is filled about 30 to about 60 percent with the particulate.

14. The device as claimed in claim 9 wherein the particulate includes a dimension of about 10 micrometers to about 60 micrometers.

15. The device as claimed in claim 1 wherein the device is an inflow control device for a resource recovery system.

16. The device as claimed in claim 1 wherein the device is a part of another inflow control device for a resource recovery system.

17. A method for controlling fluid flow through a passage comprising:
flowing a fluid in the passage;
altering a pseudoplastic material disposed at least partially within the passage based upon a density of fluid flowing in the passage.

18. The method as claimed in claim 17 wherein the altering is expanding dimensions of solid portions of the material in response to denser fluid inducing strain in the material.

19. A wellbore system comprising:
a borehole in a subsurface formation;
a string in the borehole; and
a device as claimed in claim 1 disposed within or as a part of the string.
